(19) United States
(12) Patent Application Publication
(10) Pub. No.: US 2016/0236770 A1
(43) Pub. Date: Aug. 18, 2016

(54) Electronic Control with Interchangeable Subsystem Modules

(71) Applicant: HAMILTON SUNDSTRAND CORPORATION, Charlotte, NC (US)

(72) Inventors: Charles V. DeSantis, Somers, CT (US); Rachel Welsh, Springfield, MA (US); Richard A. Poisson, Avon, CT (US)

(21) Appl. No.: 14/623,199

(22) Filed: Feb. 16, 2015

(51) Int. Cl. B64C 19/00

(52) U.S. Cl. CPC B64C 19/00

(57) ABSTRACT

A modular electronic control system is disclosed. The modular electronic control system may have a base control unit to which one or more internal subsystem module and/or external subsystem module may be mounted. Each subsystem module may perform a different function, or may connect with different sensors/effectors, however, each subsystem module has a standardized subsystem module mounting apparatus by which it can mechanically and electrically connect to the base control unit. As such, a standardized base control unit may receive any type of internal subsystem module and/or external subsystem module and intermediate communication and power provision between subsystem module and other aircraft systems, such as an aircraft data network.

### FIELD

The present disclosure relates generally to aircraft electronics, and more specifically to an electronic control with interchangeable subsystem modules.

### BACKGROUND

Aircraft electronic controls are typically designed for a specific application.

As a result, multiple controls for any given aircraft and different controls for different aircraft are typically designed and built. As a result, control systems lack common architecture and require customized layout, components, and maintenance.

### SUMMARY

The forgoing features and elements may be combined in various combinations without exclusivity, unless expressly indicated herein otherwise. These features and elements as well as the operation of the disclosed embodiments will become more apparent in light of the following description and accompanying drawings.

A modular electronic control system is disclosed. The modular electronic control system may include a base control unit having a connector bus and a subsystem module mounting apparatus having at least one electrical connector wired to the connector bus and configured to connect to at least one external subsystem module and internal system module.

An external subsystem module may include a base module mounting apparatus arranged to mechanically interface with a subsystem module mounting apparatus of a base control unit, a sensor/effector connector including at least one of an electrical connector and a wireless connection arranged to communicate with a sensor, a circuitry assembly disposed within the external subsystem module and in electrical communication with the electrical connector of the subsystem module mounting apparatus and in electrical communication with the sensor/effector connector, and an ESM cover encasing the external subsystem module.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the detailed description and claims when considered in connection with the drawing figures, wherein like numerals denote like elements.

FIG. 1 illustrates a modular electronic control system having an external subsystem module, according to various embodiments;

FIG. 2 illustrates a modular electronic control system having an internal subsystem module, according to various embodiments;

FIGS. 3-4 illustrate a modular electronic control system having a single vertically-oriented (edge mounted) external subsystem module, according to various embodiments;

FIG. 5 illustrates a modular electronic control system having multiple horizontally-oriented (side mounted) external subsystem modules, according to various embodiments; and

FIGS. 6-7 illustrate a modular electronic control system having a multiple internal subsystem modules, according to various embodiments.

### DETAILED DESCRIPTION

The detailed description of exemplary embodiments herein makes reference to the accompanying drawings, which show exemplary embodiments by way of illustration. While these exemplary embodiments are described in sufficient detail to enable those skilled in the art to practice embodiments of the disclosure, it should be understood that other embodiments may be realized and that logical changes and adaptations in design and construction may be made in accordance with this invention and the teachings herein. Thus, the detailed description herein is presented for purposes of illustration only and not limitation. The scope of the disclosure is defined by the appended claims. For example, the steps recited in any of the method or process descriptions may be executed in any order and are not necessarily limited to the order presented. Furthermore, any reference to singular includes plural embodiments, and any reference to more than one component or step may include a singular embodiment or step. Also, any reference to attached, fixed, connected or the like may include permanent, removable, temporary, partial, full and/or any other possible attachment option. Additionally, any reference to without contact (or similar phrases) may also include reduced contact or minimal contact.

Furthermore, any reference to singular includes plural embodiments, and any reference to more than one component or step may include a singular embodiment or step. Surface shading lines may be used throughout the figures to denote different parts but not necessarily to denote the same or different materials.

Aircraft control systems often are custom built and designed for both the available mechanical space, and for the electronic controls sought to be performed. As such, unique and costly control system components are custom built for functionality and for each airframe. Moreover, each control function is associated with unique wiring. In circumstances where a sensor or effector is located a significant distance from control system components, the amount of wiring can become significant, as well as the distance of electrical connections. Although aircraft are beginning to incorporate an aircraft data bus whereby different sensors and effectors can communicate with relevant control system components, the use of unique and costly control system components custom built for functionality and for each airframe persists. Various systems and methods to address these circumstances are presented herein.

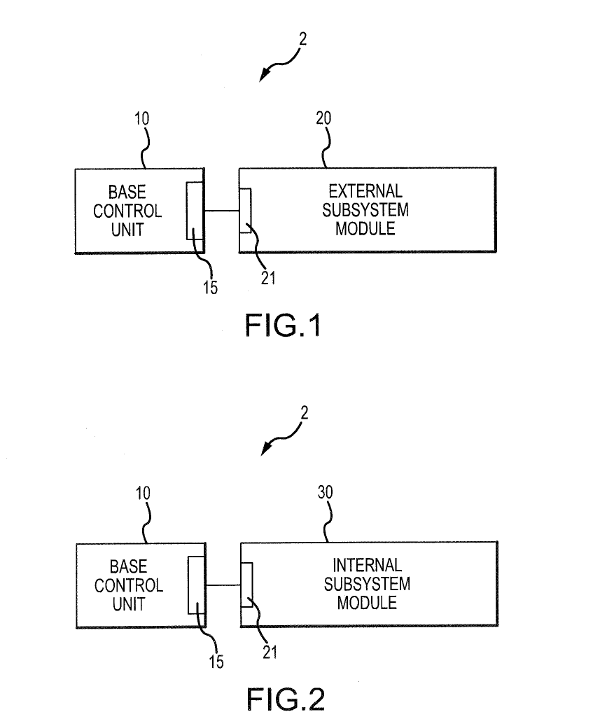

With reference to FIGS. 1 and 2, a modular electronic control system 2 is provided. The modular electronic control system 2 may provide a reconfigurable control system whereby different control functions can be mixed and matched by the changing of different modules (external subsystem module 20 and internal subsystem module 30, discussed further herein) mounted to a base (base control unit 10). The modular electronic control system 2 may provide electrical power to the different modules and may provide network interface connectivity with an aircraft data network. In this manner, the modular electronic control system 2 may be readily repurposed for different sensors, effectors, control functions, etc., by changing out different modules of the modular electronic control system 2.

The modular electronic control system 2 may comprise a base control unit 10. The base control unit 10 may provide a mounting platform whereby different modules (external subsystem module 20 and/or internal subsystem module 30) may be mechanically mounted and electrically interconnected, such as by a subsystem module mounting apparatus 15. The base control unit 10 may comprise a formed sheet metal platform. For instance, the base control unit 10 may comprise a stamped platform, or may comprise an extrusion, or may comprise a bent-up sheet metal platform. In various embodiments, the base control unit 10 may be trapezoidal. In further embodiments, the base control unit 10 may be rectangular, circular, or any desired shape.

The modular electronic control system 2 may comprise an external subsystem module 20. An external subsystem module 20 may comprise a mountable unit having a protective housing with electronics disposed inside. An external subsystem module 20 may be arranged to mechanically interface with the base control unit 10. For instance an external subsystem module 20 may have a base module mounting apparatus 21 arranged to connect to a subsystem module mounting apparatus 15 of a base control unit 10, so that the external subsystem module 20 is held in position relative to the base control unit 10. An external subsystem module 20 may have various electronics depending on the function intended for it to perform and the sensors/effectors intended for it to interact with. However, an external subsystem module 20 may comprise a standardized physical shape, whereby a variety of external subsystem modules 20 may interface with a common base control unit 10. An external subsystem module 20 may comprise a substantially trapezoidal solid, such as a rectangular cube, or a square cube, or any other shape as desired. The external subsystem module 20 may have a shape comprising a “side mounted” configuration, e.g., may have a relatively short height and a relatively wide side in contact with the base control unit 10. In further embodiments, the external subsystem module 20 may have a shape comprising an “edge mounted” configuration, e.g., may have a relatively tall height and a relatively narrow side in contact with the base control unit 10.

The modular electronic control system 2 may comprise an internal subsystem module 30. An internal subsystem module 30 may comprise a mountable unit having electronics disposed therein. The internal subsystem module 30 may be arranged to mechanically interface with the base control unit 10. However, unlike an external subsystem module 20, rather than mounting externally to the base control unit 10, the internal subsystem module 30 may be mounted into a corresponding void within the base control unit 10, e.g., may be substantially enclosed by the base control unit 10. For instance an internal subsystem module 30 may have a base module mounting apparatus 21 arranged to connect to a subsystem module mounting apparatus 15 of a base control unit 10, so that the internal subsystem module 30 is held in position relative to the base control unit 10. An internal subsystem module 30 may have various electronics depending on the function intended for it to perform and the sensors/effectors intended for it to interact with. However, an internal subsystem module 30 may comprise a standardized physical shape, whereby a variety of internal subsystem modules 30 may interface with a common base control unit 10. Moreover, in various embodiments, both internal subsystem modules 30 and external subsystem modules 20 may interface with a common base control unit 10. An internal subsystem module 30 may comprise a substantially trapezoidal solid, such as a rectangular cube, or a square cube, or any other shape as desired, or may comprise mounting hardware affixed to exposed electronics such as a circuit board.

Referring to FIGS. 1, 2 and 7, the modular electronic control system 2 may further comprise a shared internal system module (ISM) cover 31. A shared ISM cover 31 may comprise a cover mechanically attachable to the base control unit 10 and enclosing one or more internal subsystem module 30. In this manner, the one or more internal subsystem module 30 may be entirely protected from external environmental exposure, such as by being enclosed on the sides by the base control unit 10 and on the top by the shared ISM cover 31.

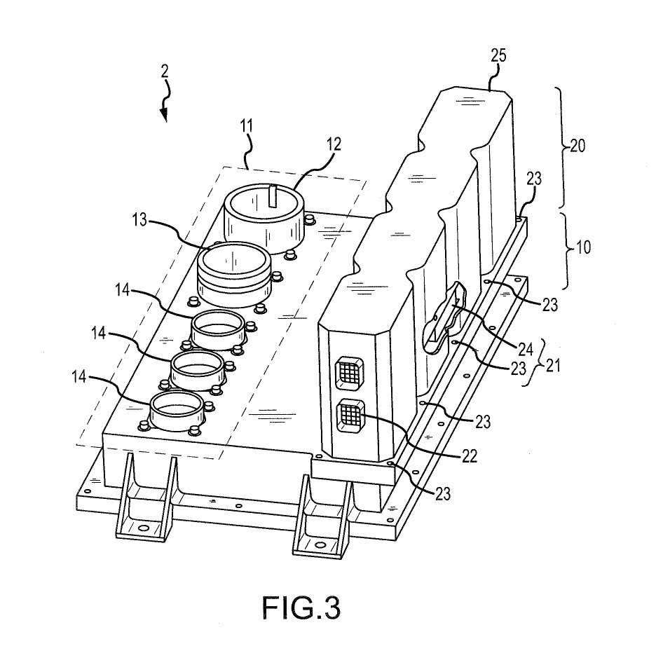

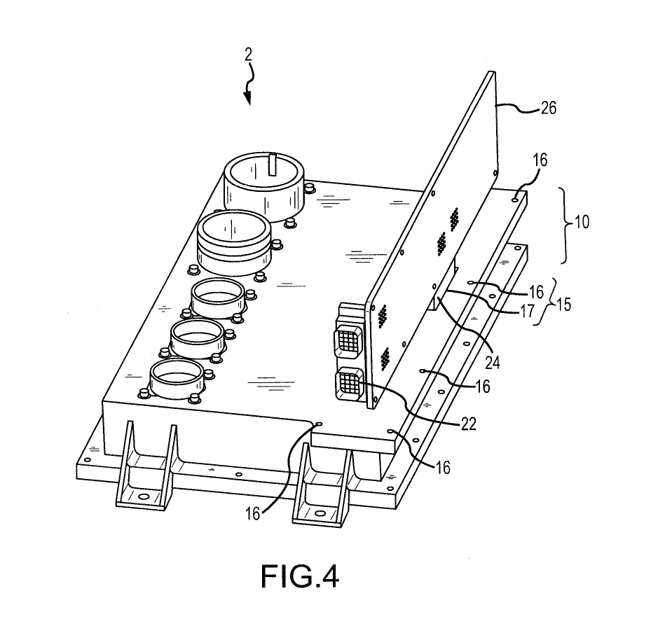

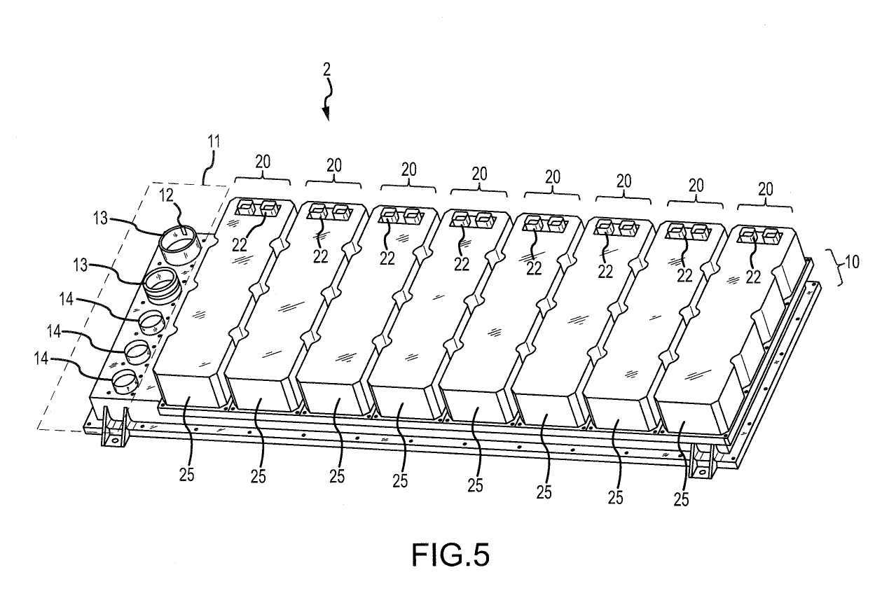

With reference to FIGS. 1-7, and referring in detail now to the base control unit 10, a base control unit 10 may have a variety of different configurations. For instance, a base control unit 10 may be configured to receive eight external subsystem modules 20 (see FIG. 5). In further embodiments, a base control unit 10 may be configured to receive a single external subsystem module 20 (See FIGS. 3-4). In still further embodiments, a base control unit 10 may be configured to receive four external subsystem modules 20, or any number of external subsystem modules 20. Moreover, external subsystem modules 20 may have differing widths. For example, a base control unit 10 configured to receive eight external subsystem modules 20 may receive four regular size external subsystem modules 20, and then receive two external subsystem modules 20 occupying twice the regular space allotted for an external subsystem module 20. In this manner, a base control unit 10 may receive any number and configuration of external subsystem modules 20, including both edge mounted external subsystem modules 20 and side mounted external subsystem modules 20. Further, as discussed, a base control unit 10 may receive a combination of any number and configuration of external subsystem modules 20, and internal subsystem modules 30.

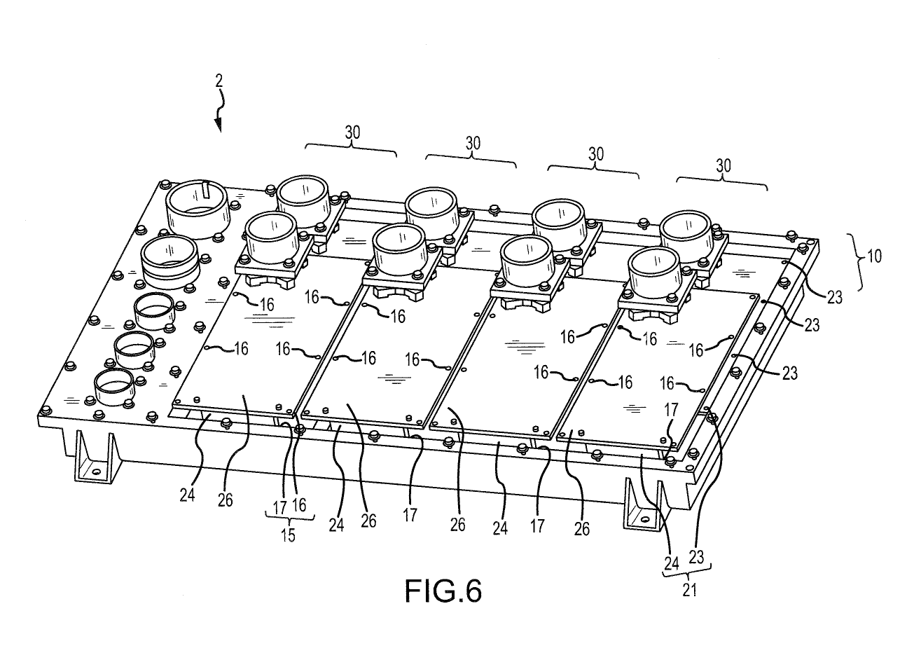

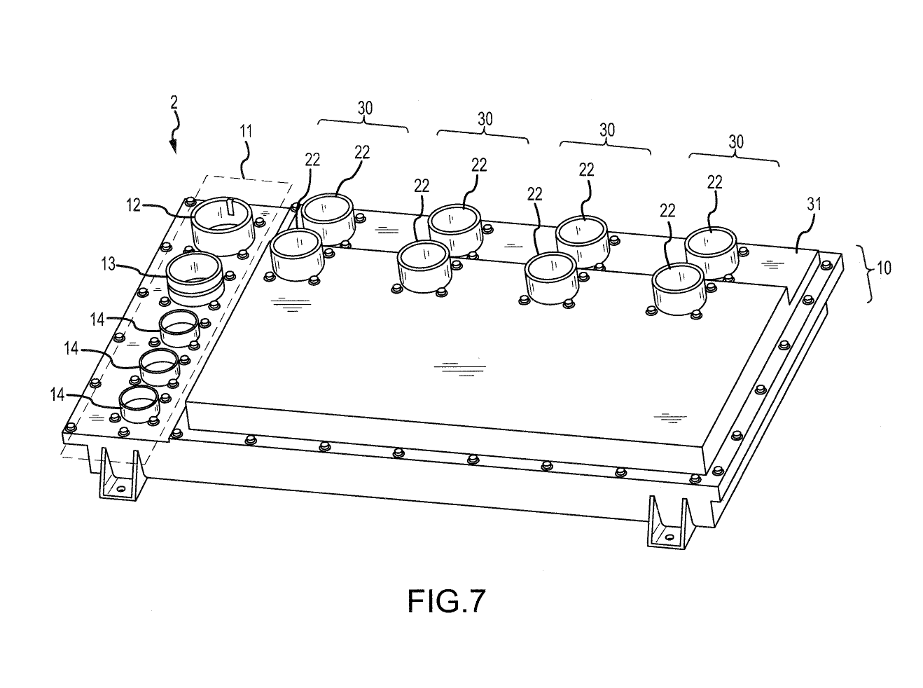

A base control unit 10 may be configured to receive eight internal subsystem modules 30. In further embodiments, a base control unit 10 may be configured to receive a single internal subsystem module 30. In still further embodiments, a base control unit 10 may be configured to receive four internal subsystem modules 30 (FIGS. 6-7), or any number of external subsystem modules 20. Moreover, internal subsystem modules 30 may have differing widths. For example, a base control unit 10 configured to receive eight internal subsystem modules 30 may receive four regular size internal subsystem modules 30, and then receive two internal subsystem modules 30 occupying twice the regular space allotted for an internal subsystem module 30. In this manner, a base control unit 10 may receive any number and configuration of internal subsystem modules 30, including both internal subsystem modules 30 and edge mounted external subsystem modules 20 and/or side mounted external subsystem modules 20.

Continuing in detailed reference to the base control unit 10 and in reference to FIGS. 3, 5, and 7, a base control unit 10 may comprise a connector bus 11. The connector bus 11 may provide for electrical connectivity between other aircraft systems, such as an aircraft data network, and electrical power sources, and the base control unit 10. In turn, the base control unit 10 may maintain connectivity with the external subsystem modules 20 and internal subsystem modules 30. In this manner, a standardized network and standardized power distribution may be incorporated into an aircraft and the base control unit 10 may enable any subsystem electronics, as installed into subsystem modules, to interoperate therewith. For instance, the connector bus 11 may comprise a power connector 13, at least one aircraft network connector 14, and a test/config connector 12. A power connector 13 may enable the connection of AC and/or DC power to the base control unit 10. A test/config connector 12 may enable the interaction with diagnostic and troubleshooting devices and systems, such as for a technician to connect test equipment. An aircraft network connector 14 may enable the interchange of data between the modular electronic control system 2 and other aircraft systems, sensors, effectors, and the like. In various embodiments, a connector bus 11 comprises three aircraft network connectors 14, which may be connected to different networks (e.g., different classification levels), or which may comprise a network switch, bridge, router, and/or the like, or any desired function. The power connector 13 and/or test/config connector 12 and/or one or more aircraft network connector 14 may comprise a D38999 connector or any desired connector. One or more aircraft network connector 14 may comprise an RJ-45 connector or any desired connector.

With reference to FIGS. 1-7, the base control unit 10 may further comprise a subsystem module mounting apparatus 15. A subsystem module mounting apparatus 15 may comprise a mechanism whereby the base control unit 10 may receive at least one of an external subsystem module 20 and internal subsystem module 30. For example, a subsystem module mounting apparatus 15 may comprise a mechanical attachment member 16 whereby the base control unit 10 and at least one of an external subsystem module 20 and internal subsystem module 30 may be mechanically joined. For instance, the mechanical attachment member 16 may interconnect to a subsystem module mechanical attachment apparatus 23 of a base module mounting apparatus 21. The subsystem module mounting apparatus 15 may further comprise an electrical connector 17 whereby an electronic connection may be made between the base control unit 10 and at least one of an external subsystem module 20 and internal subsystem module 30. For example, the electrical connector 17 may interconnect to an electrical connector 24 of a base module mounting apparatus 21.

Turning in detail now to an external subsystem module 20, the external subsystem module 20 may comprise a base module mounting apparatus 21. The base module mounting apparatus 21 may comprise a mechanism whereby the external subsystem module 20 or the internal subsystem module 30 to which it belongs is received by a subsystem module mounting apparatus 15 of a base control unit 10. For example, a base module mounting apparatus 21 may comprise a subsystem module mechanical attachment apparatus 23 whereby the base control unit 10 and at least one of an external subsystem module 20 and internal subsystem module 30 may be mechanically joined. For instance, the subsystem module mechanical attachment apparatus 23 may interconnect to a mechanical attachment member 16 of a base control unit 10. The base module mounting apparatus 21 may further comprise an electrical connector 24 whereby an electronic connection may be made between the base control unit 10 and at least one of an external subsystem module 20 and internal subsystem module 30. For example, the electrical connector 24 may interconnect to an electrical connector 17 of a subsystem module mounting apparatus 15.

The external subsystem module 20 may further comprise a sensor/effector connector 22. A sensor/effector connector 22 may comprise an electronic connection between the external subsystem module 20 and an input or output signal source, such as a sensor and/or an effector. The sensor/effector connector 22 may be any connector corresponding any sensor and/or effector, as needed to provide the correct electronic interchange with the electronics disposed in the external subsystem module 20. Thus, while each sensor/effector may require different, or customized, or unique electronic signals, connectors, and the like, because the base module mounting apparatus 21 is standardized for all external subsystem modules 20 and base control units 10, a variety of unique sensors and effectors may be interfaced and/or controlled by a modular electronic control system 2, because a variety of different external subsystem modules 20 may all be implemented in connection with the base control unit 10. In further embodiments, a sensor/effector connector 22 may comprise a wireless electromagnetic link rather than a physical connector, such as an RF connection. In still further embodiments, a sensor/effector connector 22 may comprise a fiber optic link, or any mechanism of logical connectivity.

The external subsystem module 20 may still further comprise a circuitry assembly 26. A circuitry assembly 26 may comprise the electronic components, such as a circuit board, arranged to receive and output signals among the sensor/effector connector 22, and the electrical connector 24 of the base module mounting apparatus 21. In this manner, unique and varied processing functions may be implemented on a standardized mechanical arrangement of base control units 10 and external subsystem modules 20.

Finally, the external subsystem module 20 may comprise an external system module (ESM) cover 25. An ESM cover 25 may comprise a protective cover disposed over the circuitry assembly 26 and providing structural support to the base module mounting apparatus 21, sensor/effector connector 22, and circuitry assembly 26. The ESM cover 25 may comprise a stamped enclosure, or may comprise an extrusion, or may comprise a bent-up sheet metal enclosure, or any desired enclosure. In various embodiments, the ESM cover 25 may be trapezoidal. In further embodiments, the ESM cover 25 may be rectangular, square or any desired shape.

Turning now in greater detail to the features of a subsystem module mounting apparatus 15 of a base control unit 10, particularly, a mechanical attachment member 16, a mechanical attachment member 16 may comprise an arrangement of apertures, for instance, threaded apertures, whereby fasteners may be inserted through at least one of an external subsystem module 20 and/or an internal subsystem module 30 and into the base control unit 10. A mechanical attachment member 16 may further or alternatively comprise a latch, or a hinge, or a snap whereby an external subsystem module 20 and/or internal subsystem module 30 may be retained in fixed position relative to the base control unit 10.

The subsystem module mounting apparatus 15 may also comprise an electrical connector 17. Turning now in greater detail to the features of the electrical connector 17, the electrical connector 17 may comprise an electronic connection between the external subsystem module 20 and base control unit 10. The electrical connector 17 may be a standardized connector consistently implemented for all external subsystem modules 20 to correspond to all base control units 10, as needed to provide the correct electronic interchange with the electronics disposed in the external subsystem module 20 and with the base control unit 10. As such, while each sensor/effector may require different, or customized, or unique electronic signals, connectors, and the like, because the subsystem module mounting apparatus 15 (including electrical connector 17) of base control unit 10 is standardized a variety of different external subsystem modules 20 may all be implemented in connection with the base control unit 10.

Turning now in greater detail to the features of a base module mounting apparatus 21 of an external subsystem module 20 and/or internal subsystem module 30, particularly, a subsystem module mechanical attachment apparatus 23, a subsystem module mechanical attachment apparatus 23 may comprise an arrangement of apertures, for instance, threaded apertures, whereby fasteners may be inserted through at least one of an external subsystem module 20 and/or an internal subsystem module 30 and into the base control unit 10. A subsystem module mechanical attachment apparatus 23 may further or alternatively comprise a latch, or a hinge, or a snap whereby at an external subsystem module 20 and/or internal subsystem module 30 may be retained in fixed position relative to the base control unit 10.

The base module mounting apparatus 21 may also comprise an electrical connector 24. Turning now in greater detail to the features of the electrical connector 24, the electrical connector 24 may comprise an electronic connection between the external subsystem module 20 and base control unit 10. The electrical connector 24 may be a standardized connector consistently implemented for all internal subsystem modules 30 and/or external subsystem modules 20 to correspond to all base control units 10, as needed to provide the correct electronic interchange with the electronics disposed in the internal subsystem module 30 and/or external subsystem module 20 with the base control unit 10. As such, while each sensor/effector may require different, or customized, or unique electronic signals, connectors, and the like, because the base module mounting apparatus 21 (including electrical connector 24) is standardized a variety of different internal subsystem modules 30 and/or external subsystem modules 20 may all be implemented in connection with the base control unit 10.

In further embodiments, various components may comprise different, but corresponding mounting apparatus. For example, a mechanical attachment member 16 of a subsystem module mounting apparatus 15 may comprise a latch and the subsystem module mechanical attachment apparatus 23 of a base module mounting apparatus 21 may comprise a pin.

Various benefits and advantages have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, and any elements that may cause any benefit or advantage to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C.

The foregoing features and elements may be combined in various combinations without exclusivity, unless expressly indicated otherwise. These features and elements as well as the operation thereof will become more apparent in light of the following description and the accompanying drawings. It should be understood, however, the following description and drawings are intended to be exemplary in nature and non-limiting.

Systems, methods and apparatus are provided herein. In the detailed description herein, references to “various embodiments”, “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f), unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

1. A modular electronic control system comprising a base control unit comprising:
a connector bus; and
a subsystem module mounting apparatus comprising at least one electrical connector wired to the connector bus and configured to connect to at least one external subsystem module or internal system module.

2. The modular electronic control system according to claim 1, further comprising a first external subsystem module mounted to the subsystem module mounting apparatus.

3. The modular electronic control system according to claim 2, further comprising a second external subsystem module mounted to the subsystem module mounting apparatus.

4. The modular electronic control system according to claim 3, the first external subsystem module having a shape comprising an edge mounted configuration, and the second external subsystem module having a shape comprising a side mounted configuration.

5. The modular electronic control system according to claim 2, the first external subsystem module comprising a mountable unit having a protective housing with electronics disposed inside and comprising a base module mounting apparatus arranged to mechanically interface with the subsystem module mounting apparatus.

6. The modular electronic control system according to claim 1, further comprising an external subsystem module comprising:
a base module mounting apparatus arranged to mechanically interface with the subsystem module mounting apparatus;
a sensor/effector connector comprising at least one of an electrical connector or a wireless connection arranged to communicate with a sensor;
a circuitry assembly disposed within the external subsystem module and in electrical communication with the electrical connector of the subsystem module mounting apparatus and in electrical communication with the sensor/effector connector;
and an ESM cover encasing the external subsystem module.

7. The modular electronic control system according to claim 6, wherein the base module mounting apparatus comprises:
a subsystem modular mechanical attachment apparatus connectable to the base module mounting apparatus of the external subsystem module; and
and an electrical connector connectable to the electrical connector of the external subsystem module.

8. The modular electronic control system according to claim 1, further comprising a first internal subsystem module mounted to the subsystem module mounting apparatus.

9. The modular electronic control system according to claim 8, further comprising a second internal subsystem module mounted to the subsystem module mounting apparatus.

10. The modular electronic control system according to claim 9, further comprising:
a shared ISM cover selectably attachable to the base control unit and covering the first internal subsystem module and the second internal subsystem module.

11. The modular electronic control system according to claim 1, further comprising an internal subsystem module disposed at least partially within a void defined by the base control unit and having electronics disposed inside and comprising a base module mounting apparatus arranged to mechanically interface with the subsystem module mounting apparatus.

12. The modular electronic control system according to claim 1 further comprising an internal subsystem module comprising:
a base module mounting apparatus arranged to mechanically interface with the subsystem module mounting apparatus;
a sensor/effector connector comprising at least one of an electrical connector or a wireless connection arranged to communicate with a sensor;
a circuitry assembly disposed within the internal subsystem module and in electrical communication with the electrical connector of the subsystem module mounting apparatus and in electrical communication with the sensor/effector connector,
wherein the internal subsystem module is disposed at least partially within a void defined by the base control unit.

13. The modular electronic control system according to claim 12, wherein the base module mounting apparatus comprises:
a subsystem modular mechanical attachment apparatus connectable to the base module mounting apparatus of the internal subsystem module; and
an electrical connector connectable to the electrical connector of the internal subsystem module.

14. The modular electronic control system according to claim 1, the connector bus comprising:
a power connector configured to receive electrical power and wired to an electrical connector of the subsystem module mounting apparatus;
an aircraft network connector wired to the electrical connector of the subsystem module mounting apparatus and configured to transceive data.

15. An external subsystem module comprising:
a base module mounting apparatus arranged to mechanically interface with a subsystem module mounting apparatus of a base control unit;
a sensor/effector connector comprising at least one of: an electrical connector and a wireless connection arranged to communicate with a sensor;
a circuitry assembly disposed within the external subsystem module and in electrical communication with the electrical connector of the subsystem module mounting apparatus and in electrical communication with the sensor/effector connector; and
an ESM cover encasing the external subsystem module.
